(19) United States
(12) Patent Application Publication
(10) Pub. No.: US 2013/0202340 A1
(43) Pub. Date: Aug. 8, 2013

(54) KEY DEVICE

(71) Applicant: Qing Zhang, Changshu (CN)

(72) Inventor: Qing Zhang, Changshu (CN)

(21) Appl. No.: 13/367,850

(22) Filed: Feb. 7, 2012

(51) Int. Cl. B41J 5/12

(52) U.S. Cl. 400/490

(57) ABSTRACT

A key device includes a casing having a base plate and a frame disposed on the base plate, and a key cap having a press plate and a limiter. The press plate is disposed between the frame and the base plate and exposed from an opening of the frame. The press plate has a pivotal side connected pivotally to the frame or base plate and is movable between unpressed and pressed positions. The limiter is disposed at or near a non-pivotal side of the press plate opposite to the pivotal side and engageable with the base plate or frame to prevent the non-pivotal side from escaping out of the casing. A resilient unit is disposed on the base plate to bias the press plate to the unpressed position.

### BACKGROUND OF THE INVENTION

1. Field of the Invention

The invention relates to a key device, more particularly to a key device adapted for use by a computer.

2. Description of the Related Art

A key device generally includes a casing, a key cap and a support unit mounted in the casing for supporting the key cap to move up and down. In order to move the key cap up and down stably, a conventional key device is provided with a scissor-type support unit as disclosed in Taiwan Patent Publication Number M405002. Such a scissor-type support has an effect of dispersing exert forces so that no matter which part, such as a central portion, a lateral side, or a corner, of the key cap is depressed, the scissor-type support can make the key cap to ascend and descend vertically. With the use of the scissor-type support, convenience and stability can be achieved.

However, the scissor-type support is made up of multiple component parts, which require cumbersome assembly steps and produce a lot of connection joints, thereby resulting in a complicated structure and an increased volume and size.

### SUMMARY OF THE INVENTION

An object of this invention is to provide a key device that has a simple and miniaturized structure and that is easy for assembly.

Accordingly, the present invention provides a key device which comprises a casing, a key cap, a connection unit and a resilient unit.

The casing has a base plate, a frame disposed on the base plate, and a receiving space formed between the base plate and the frame. The frame has an opening communicated with the receiving space. The key cap has a press plate and a limiter. The press plate is disposed in the receiving space and exposed from the opening, and has a pivotal side and a non-pivotal side opposite to the pivotal side. The limiter is disposed near or at the non-pivotal side and is engageable with one of the frame and the base plate to limit said non-pivotal side from moving out of said opening. The connection unit includes first and second pivot connections. The first pivot connection is disposed near or at the pivotal side of the press plate. The second pivot connection is disposed on one of the frame and the base plate. The first and second connections are interconnected pivotally so that the press plate is pivotal between an unpressed state, and a pressed state in which the press plate is pressed toward the base plate. The resilient unit is disposed on the base plate and biases the press plate to move to the unpressed state. The non-pivotal side is movable upward or downward above the base plate. The limiter engages the frame or base plate when the press plate is in the unpressed state, and disengages from the frame or base plate when the press plate in the pressed state.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded view of a key device according to the first preferred embodiment of the present invention;

FIG. 2 is a top view of the first preferred embodiment;

FIG. 3 is a side sectional view taken along line of FIG. 2;

FIG. 4 is the same view as FIG. 3 but illustrating a press plate in a pressed state;

FIG. 5 is an exploded perspective view of the second preferred embodiment of the present invention;

FIG. 6 is an exploded perspective view of the third preferred embodiment of the present invention;

FIG. 7 is an exploded perspective view of the fourth preferred embodiment of the present invention;

FIG. 8 is an exploded perspective view of the fifth preferred embodiment of the present invention;

FIG. 9 is an exploded perspective view of the sixth preferred embodiment of the present invention;

FIG. 10 is an exploded perspective view of the seventh preferred embodiment of the present invention;

FIG. 11 is an exploded perspective view of the eighth preferred embodiment of the present invention; and

FIG. 12 is an exploded perspective view of the ninth preferred embodiment of the present invention.

### DETAILED DESCRIPTION OF THE PREFERRED EMBODIMENTS

Before the present invention is described in greater detail with reference to the accompanying preferred embodiment, it should be noted herein that like elements are denoted by the same reference numerals throughout the disclosure.

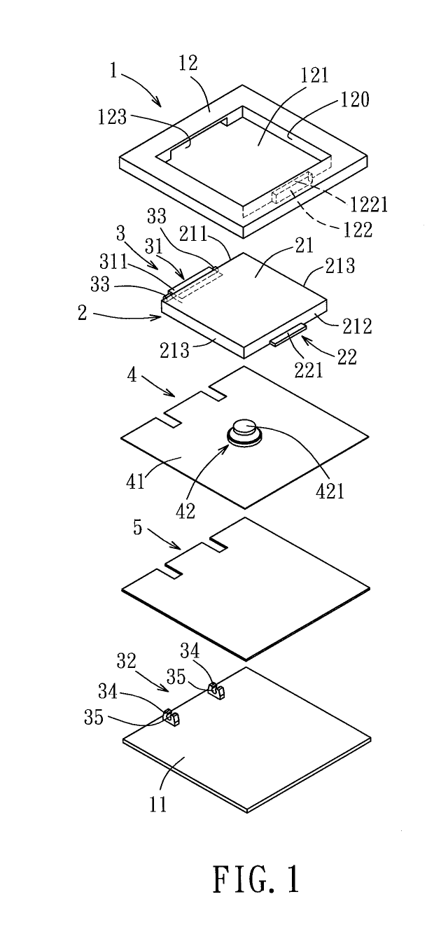

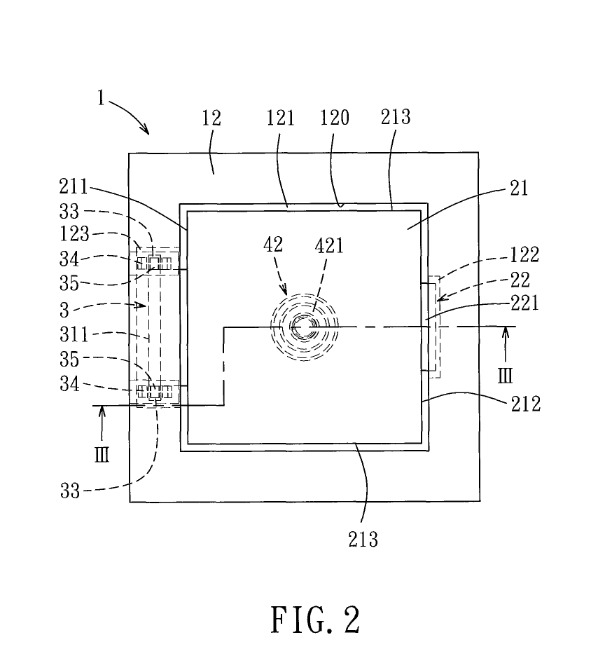

Referring to FIGS. 1, 2 and 3, the first preferred embodiment of a key device of this invention is shown to include a casing 1, a key cap 2, a connection unit 3, a resilient unit 9 and a circuit board unit 5.

The casing 1 has a base plate 11, a frame 12 disposed on the base plate 11, and a receiving space 13 defined by the base plate 11 and the frame 12. The frame 12 has an inner peripheral wall 120 that confines the receiving space 13 and that defines an opening 121 on top of and in communication with the receiving space 13.

The key cap 2 is disposed in the casing 1 and spaced apart from the base plate 11, and has a press plate 21 and a limiter 22. The press plate 21 is disposed in the receiving space 13 and exposed from the opening 121. The press plate 21 has a pivotal side 211, a non-pivotal side 212 opposite to the pivotal side 211, and two spaced apart lateral sides 213 each having two ends connected respectively to the pivotal side 211 and the non-pivotal side 212. The limiter 22 is disposed near or at the non-pivotal side 212 and is engageable with the base plate 11 or the frame 12 to limit the non-pivotal side 212 from moving out of the opening 121 of the casing 1. The limiter 22 is movable upward and downward above the base plate 11 and disengages from the base plate 11 or the frame 12 when the press plate 21 is pressed toward the base plate 11.

In this embodiment, the limiter 22 includes one protrusion 221 projecting laterally from the non-pivotal side 212 of the press plate 21. The frame 12 further has a limit recess 122 indented from the inner peripheral wall 120 to receive the protrusion 221, and a recess upper wall 1221 bounding a top of the limit recess 122. The protrusion 221 is engageable with the recess upper wall 1221 when the press plate 21 is not pressed.

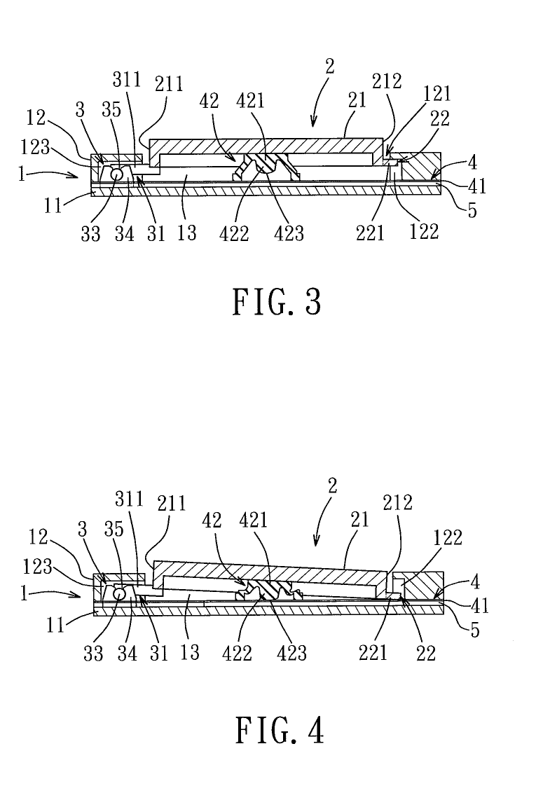

The connection unit 3 includes first and second pivot connections 31, 32 interconnected pivotally to each other. The first pivot connection 31 is disposed at the pivotal side 211 of the press plate 21. The second pivot connection 32 is disposed on the base plate 11 of the casing 1. The frame 12 further has a receiving recess 123 indented from the inner peripheral wall 120 of the frame 12 to receive the first and second pivot connections 31, 32. The first pivot connection 31 has a connection body 311 connected to the press plate 21, and a pivot spindle disposed in the connection body 311 and having two pivot ends 33 projecting outwardly from two ends of the connection body 311, respectively. The second pivot connection 32 has a pair of seat bodies 34 connected to the base plate 11 and respectively aligned with the two pivot ends 33. The seat bodies 34 have aligned grooves 35 to receive and journal the pivot ends 33. The press plate 21 is connected pivotally to the casing through the interconnected first and second pivot connections 31, 32 and is movable between an unpressed state (as best shown in FIG. 3), and a pressed state (as best shown in FIG. 4) in which the press plate 21 is pressed toward the base plate 11.

Referring again to FIGS. 1, 2 and 3, the resilient unit 4 is disposed in the casing 1, and has a resilient plate 41 disposed between the press plate 21 and the base plate 11, and a spring member 42 formed integrally on the resilient plate 41. The spring member 42 abuts against the press plate 21 to bias the press plate 21 to move to the unpressed state. The spring member 42 has a substantially frustro-conical hollow body and includes a head part 421 that abuts against the press plate 21, and a contact part 422 protruding downward from the head part 421 and having a bottom end formed with a conductive member 423. In this embodiment, the spring member 42 is made of an insulative rubber material, and the conductive member 423 is made from a conductive carbon powder.

Referring to FIGS. 3 and 4, the circuit board unit 5 is disposed between the resilient unit 4 and the base plate 11. When the press plate 21 is in the pressed state as shown in FIG. 4, the non-pivotal side 212 of the press plate 21 moves downward and disengages from the recess upper wall 1221 of the frame 12. The press plate 21 presses the spring member 42 so that the contact part 422 abuts against the circuit board unit 5 and the conductive member 423 is in electrical contact with the circuit board unit 5 to generate an electric signal. When a pressure on the press plate 21 is removed, by virtue of the returning force of the spring member 42, the press plate 21 is moved back to the unpressed position as shown in the FIG. 3. At this state, because the limiter 22 engages the frame 12, the press plate 21 does not move out of the frame 12.

In this embodiment, the contact part 422 has a bottom end provided with the conductive member 423, and the circuit board unit 5 is a single layer thin film circuit board. When the spring member 42 is depressed, an electrical connection is established between the spring member 42 and the circuit board unit 5. In an alternative embodiment, the circuit board unit 5 may be a three-layer thin film circuit board and the spring member 42 is not necessarily provided with the conductive member 423. The three-layer thin film circuit board has an upper layer, a lower layer and a middle layer disposed between the upper and lower layers. In the position aligned with the spring member 42, apart of the middle layer is removed, and conductive layers are provided on inner sides of the corresponding upper and lower layers. When the contact part 422 of the spring member 42 is depressed to abut against the upper layer, the upper layer is moved downward such that the conductive layers of the upper and lower layers contact each other resulting in an electric connection therebetween. In this case, the spring member 42 may be in the form of a metal part with a central downward protrusion.

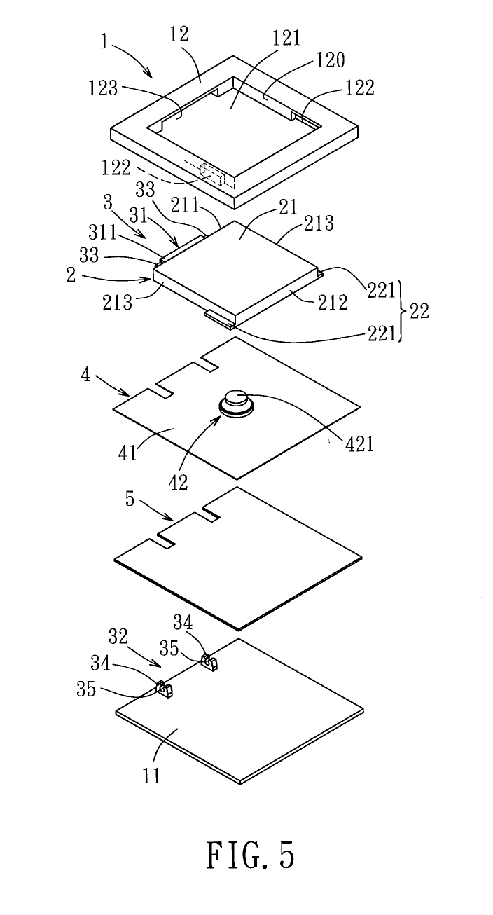

Referring to FIG. 5, the second preferred embodiment of this invention is shown to be generally identical to the first preferred embodiment. However, in the second preferred embodiment, the limiter 22 includes two protrusions 221 projecting respectively from the lateral sides 213 of the press plate 21 near the non-pivotal side 212, and the frame 12 has two limit recesses 122 to receive the protrusions 221, respectively.

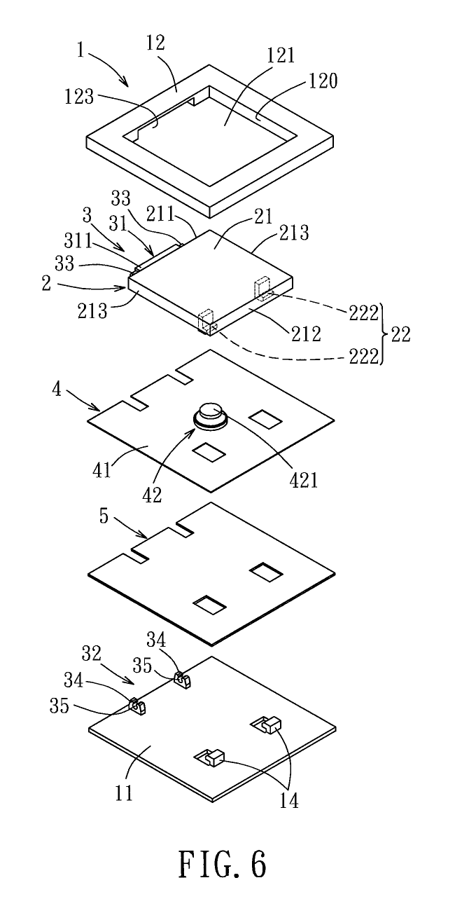

Referring to FIG. 6, the third preferred embodiment of this invention is shown to be generally identical to the first preferred embodiment. However, in the third preferred embodiment, the protrusions are formed as first hooks 222 projecting downward at a bottom side of the press plate 21 near the non-pivotal side 212. The base plate 11 has a pair of second hooks 14 projecting upward and registered with the respective first hooks 222. The first hooks 222 engage the respective second hooks 14 when the press plate 21 is in the unpressed position to retain the press plate 21. The resilient plate 41, the circuit board unit 5 and the base plate 11 are formed with orifices 411, 51 and 111 for passage and displacement of the first hooks 222. When the press plate 21 is in the pressed position, the lower ends of the first hooks 222 pass through the respective orifices 411, 51 and extend into the respective orifices 111.

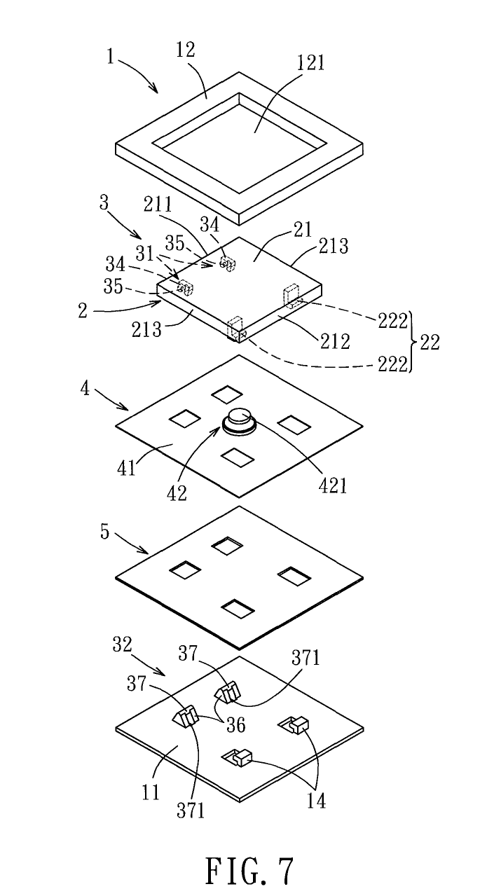

Referring to FIG. 7, the fourth preferred embodiment of this invention is shown to be generally identical to the third preferred embodiment. However, in the fourth preferred embodiment, the second pivot connection 32 includes a pair of seat bodies 36 disposed on the base plate 11 and respectively formed with cylindrical pivot spindles 37 aligned with each other. Two opposite indentations 371 (only one is shown) are formed adjacent the cylindrical pivot spindle 37 in each seat body 36. The first pivot connection 31 includes a pair of connection bodies 34 formed on the bottom side of the press plate 21 in alignment with the seat bodies 36, and aligned grooves 35 formed by indenting the connection bodies 34 to receive and journal the respective cylindrical pivot spindles 37. Each connection body 34 extends into the indentations 371 in the corresponding seat body 36 when the corresponding groove 35 receives the corresponding cylindrical pivot spindle 37. The resilient plate 41 and the circuit board unit 5 are formed with apertures 412, 52 for the second pivot connection 32 to extend through the resilient plate 41 and the circuit board unit 5 and to connect with the first pivot connection 31.

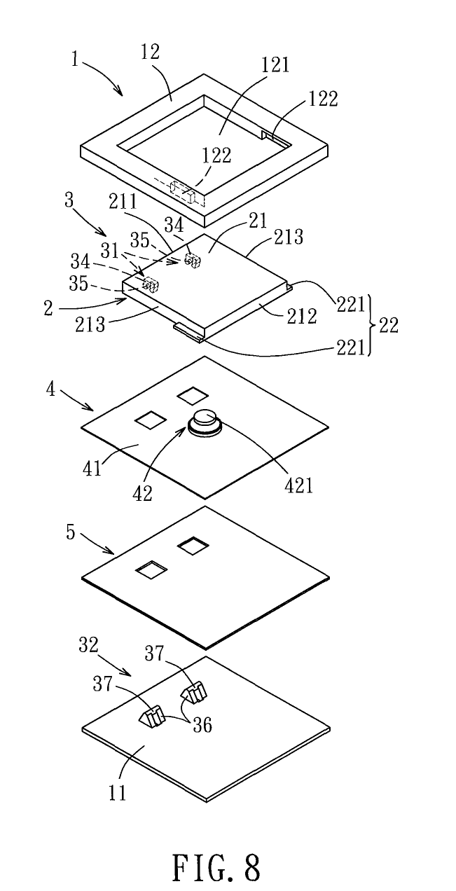

Referring to FIG. 8, the fifth preferred embodiment of the key device of this invention is shown to be generally identical to the fourth preferred embodiment. However, in the fifth preferred embodiment, the two protrusions 221 projecting respectively from the lateral sides 213 of the press plate 21 near the non-pivotal side 212, and the frame 12 has two limit recesses 122 to receive the protrusions 221, respectively. The limit recesses 122 prevent upward movement of the protrusions 221 thereby limiting the press plate 21 from moving outward.

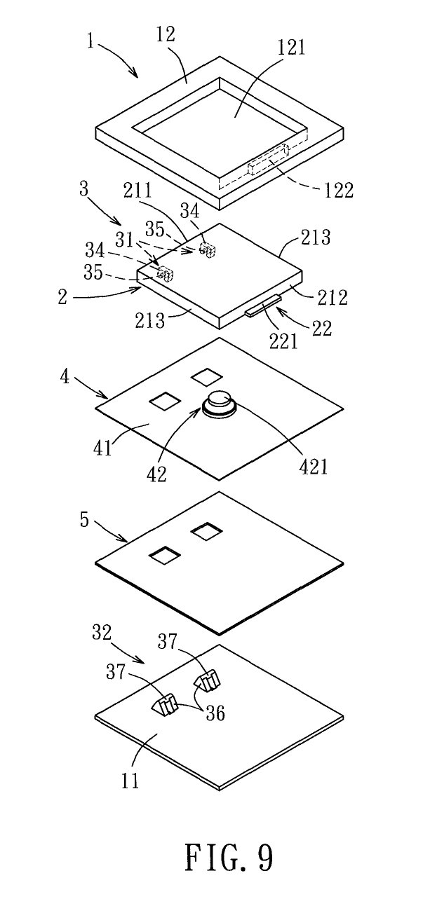

Referring to FIG. 9, the sixth preferred embodiment of this invention is shown to be generally identical to the fourth preferred embodiment. However, in the sixth preferred embodiment, the protrusion 221 projects from the non-pivotal side 212 of the press plate 21 into the limit recess 122 of the frame 12.

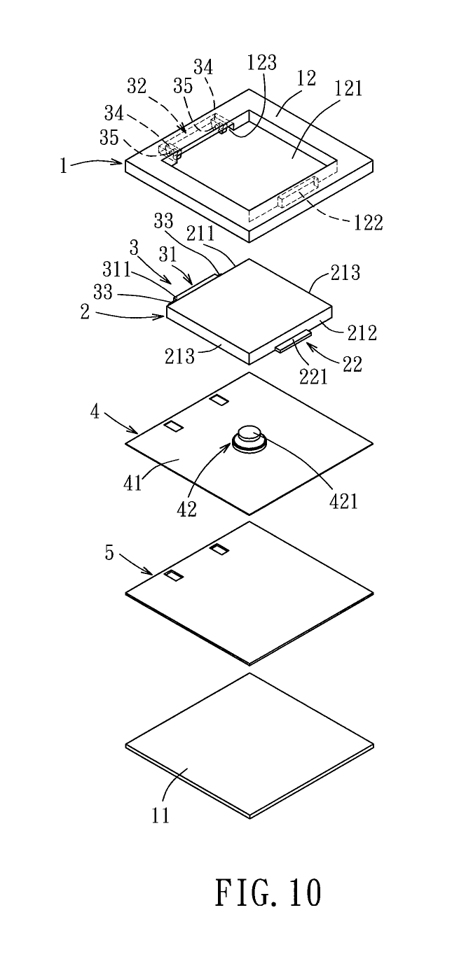

Referring to FIG. 10, the seventh preferred embodiment of this invention is shown to be generally identical to the first preferred embodiment. However, in the seventh preferred embodiment, the second pivot connection 32 is provided on an inner wall bounding the receiving space 123 of the frame 12.

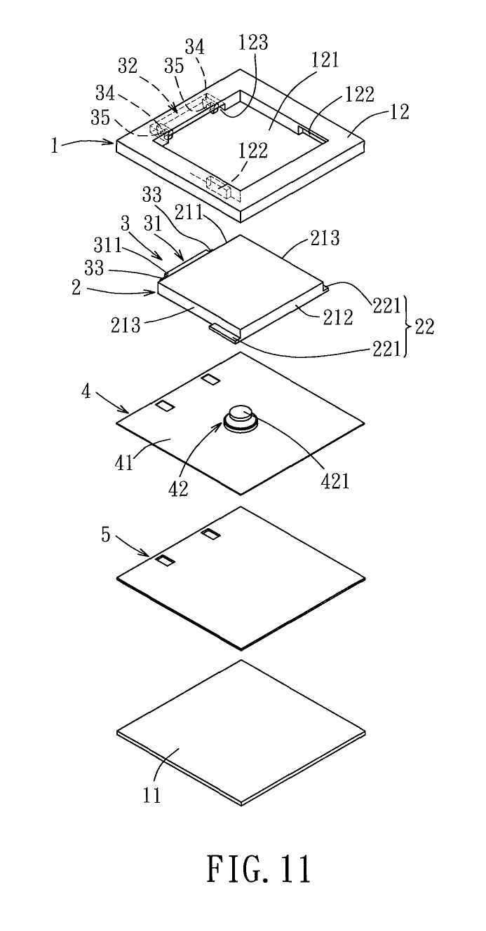

Referring to FIG. 11, the eighth preferred embodiment of this invention is shown to be generally identical to the second prefer red embodiment. However, in the eighth preferred embodiment, the second pivot connection 32 is provided on an inner wall bounding the receiving space 123 of the frame 12.

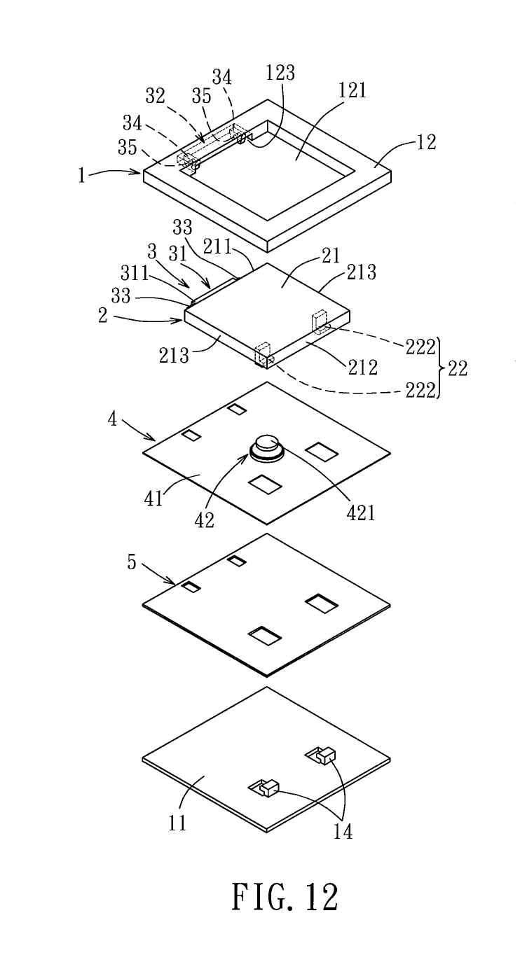

Referring to FIG. 12, the ninth preferred embodiment of this invention is shown to be generally identical to the third preferred embodiment. However, in the ninth preferred embodiment, the second pivot connection 32 is provided on an inner wall bounding the receiving space 123 of the frame 12.

For assembly, firstly, the circuit board unit 5 and the resilient unit 4 are stacked on the base plate 11. Because the circuit board unit 5 and the resilient plate 41 of the resilient unit 4 are formed as plates, they can be easily aligned with each other. Thereafter, the connection unit 3 is used to connect the key cap 2 to the base plate 11 or the frame 12. Finally, the base plate 11 and the frame 12 are coupled together to complete assembly. The entire assembly process is simple and easy. In addition, the size of the key device is miniaturized and thinned.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A key device comprising:
a casing having a base plate, a frame disposed on said base plate, and a receiving space defined by said base plate and said frame, said frame having a top opening opposite to said base plate and communicated with said receiving space;
a key cap having a press plate and a limiter, said press plate being disposed in said receiving space and exposed from said opening, said press plate having a pivotal side and a non-pivotal side opposite to said pivotal side, said limiter being disposed near or at said non-pivotal side and engageable with one of said frame and said base plate to limit said non-pivotal side from moving out of said opening;
a connection unit including first and second pivot connections, said first pivot connection being disposed near or at said pivotal side of said press plate, said second pivot connection being disposed on one of said frame or said base plate, said first and second connection being interconnected pivotally so that said press plate is pivotal between an unpressed state, and a pressed state in which said press plate is pressed toward said base plate; and
a resilient unit disposed on said base plate and biasing said press plate to move to said unpressed state,
wherein said non-pivotal side is movable upward or downward above said base plate, said limiter engages said frame or said base plate when said press plate is in said unpressed state and disengages from said frame or base plate when said press plate in said pressed state.

2. The key device of claim 1, wherein said resilient unit has a resilient plate disposed over said base plate, and a spring member formed integrally on said resilient plate and abutting against said press plate.

3. The key device of claim 1, wherein said second pivot connection is disposed on one of said base plate and said frame, one of said first and second pivot connections has at least one pivot spindle, and the other one of said first and second pivot connections has at least one groove to receive and journal said pivot spindle.

4. The key device of claim 3, wherein said second pivot connection is disposed on said frame, one of said first and second pivot connections has a pair of said pivot spindles, and the other one of said first and second pivot connections has a pair of said grooves to receive and journal said pivot spindles, respectively.

5. The key device of claim 1, wherein said limiter includes at least one protrusion projecting from said press plate near or at said non-pivotal side to engage one of said frame and said base plate.

6. The key device of claim 5, wherein said frame has a bottom face facing said base plate, and an inner peripheral wall that defines said receiving space on said base plate and that further defines said opening on top of said receiving space.

7. The key device of claim 6, wherein said protrusion projects laterally from said press plate, said frame further having a limit recess indented from said inner peripheral wall to receive said protrusion, and a recess upper wall bounding a top of said limit recess, said protrusion being engageable with said recess upper wall.

8. The key device of claim 7, wherein said protrusion projects from said non-pivotal side of said press plate.

9. The key device of claim 7, wherein said limiter includes two said protrusions, said press plate further having two spaced apart lateral sides interconnecting said pivotal side and said non-pivotal side, said protrusions projecting oppositely and respectively at said lateral sides near said non-pivotal side, said frame having two said limit recesses indented from said inner peripheral wall to receive said protrusions, respectively.

10. The key device of claim 6, wherein said protrusion is formed as a first hook that projects downwardly from said press plate near said non-pivotal side, said base plate having a second hook projecting upwardly from said base plate, said first hook being engaged with said second hook when said press plate is in said unpressed position.

11. The key device of claim 2, further comprising a circuit board unit disposed between said resilient unit and said base plate, said spring member including a substantially frustro-conical hollow body that has a head part to abut against said press plate, and a contact part protruding downward from said head part and toward said circuit board unit, said contact part being in electrical contact with said circuit board unit when said press plate is in said pressed position.

12. The key device of claim 11, wherein said circuit board unit is a thin film circuit board.
